(19) United States
(12) Patent Application Publication
(10) Pub. No.: US 2002/0018626 A1
(43) Pub. Date: Feb. 14, 2002

(54) Optical transceiver module and method for coupling light into and out of an optical transceiver module

(76) Inventors: Gustav Muller, Regensburg (DE); Hans Hurt, Regensburg (DE); Andreas Neyer, Iserlohn (DE)

Correspondence Address: Lerner and Greenberg, P.A., P.O. Box 2480, Hollywood, FL, 33022-2480, US

(21) Appl. No.: 09/909,389

(22) Filed: Jul. 19, 2001

(30) Foreign Application Priority Data
Jul. 19, 2000 (DE) 100 36 357.1

(51) Int. Cl. G02B 6/42

(52) U.S. Cl. 385/88

(57) ABSTRACT

The invention relates to an optical transceiver module having a circuit board for accommodating electronic components and having at least one optoelectronic transducer. The invention also relates to a method for coupling light into and out of an optical transceiver module. The at least one optoelectronic transducer is configured on one side of the circuit board in such a way that light is coupled in or coupled out essentially perpendicular to the circuit board plane and, in the process, directly from or to the other side of the circuit board.

### BACKGROUND OF THE INVENTION

Field of the Invention

The invention relates to an optical transceiver module having an optoelectronic component and a circuit board for accommodating electronic components and the invention relates to a method of coupling light into or out of an optoelectronic component.

Optical transceiver modules conventionally include circuit boards which are populated with electronic modules and onto which the required optoelectronic transducers are additionally mounted. Passive optical functional elements such as couplers, splitters and wavelength division multiplexing (WDM) filters are in this case realized by additional external components. Transceiver modules of this type are relatively expensive to produce, and so they are not suitable for mass production. In particular, the light guidance and alignment of the individual components on the circuit board are complicated and thus cost-intensive.

Furthermore, transceiver modules based on lead frame technology are known. In this case, the transceiver modules are usually configured in cast or injection-molded housings. Although modules of this type are relatively cost-effective, their optical functionality is limited on account of the lead frame, which is only coarsely structured. Moreover, passive optical functions have not been realized heretofore. In addition, application is restricted to a temperature range up to approximately 85° C. on account of the required transparent casting resins or molding compounds.

### SUMMARY OF THE INVENTION

It is accordingly an object of the invention to provide an optical transceiver module and a method for coupling light into and out of an optical transceiver module which overcomes the above-mentioned disadvantageous of the prior art apparatus and methods of this general type. In particular, it is an object of the invention to provide such a module and a method for coupling light so that cost-effective production of the optical module in conjunction with a high quality standard can be obtained.

With the foregoing and other objects in view there is provided, in accordance with the invention an optical transceiver module that includes a circuit board for accommodating electronic components. The circuit board has a first side and a second side that is located opposite the first side. The circuit board defines a circuit board plane. The optical transceiver module also includes at least one optoelectronic transducer that is located on the first side of the circuit board such that light is directly coupled between the optoelectronic component and the second side of the circuit board and such that the light is coupled essentially perpendicularly to the circuit board plane.

At least one optoelectronic transducer is configured on one side of the circuit board in such a way that light is coupled in or coupled out essentially perpendicularly to the circuit board plane and, in the process, directly from or to the other side of the circuit board. Such an configuration opens up the possibility of arranging the optoelectronic transducer or transducers on one side of the circuit board together with the required electronic modules, while the light feeding and associated passive optical functions are realized separately from this on the other side of the circuit board. In this case, light is coupled to the optoelectronic transducer directly from the other side of the circuit board, thereby obviating separate optical waveguides on the side of the circuit board on which the transducer is configured. This considerably simplifies the production and alignment outlay.

In addition, in the case of the invention's spatial separation of the optoelectronic transducer and light guidance and passive optical functions, the optical transceiver module can be more easily encapsulated by a plastic, for example an epoxy potting compound, by molding, without potting material getting into the optical beam path.

In accordance with an added feature of the invention, the light is coupled into the transducer or coupled out of the transducer through an opening in the circuit board. In this case, the light is directly coupled to the transducer, without additional light-guiding elements being necessary. An opening in the circuit board can be obviated if the circuit board or the support material of the circuit board is designed to be transparent.

The optoelectronic transducers used is preferably an LED (Light-Emitting Diode), a VCSEL (Vertical Cavity Surface Emitting Laser) or a photodiode. The light exit direction or the light entry direction in each case is perpendicular to the circuit board plane. As a result, light is directly coupled in or out without the need for light-guiding means on that side of the circuit board on which the transducer is configured. The use of a VCSEL is particularly advantageous because the emitted light is radiated directly perpendicularly to the circuit board plane.

In accordance with an additional feature of the invention, on the side of the circuit board which is remote from the transducer, the light is optically coupled to an optical waveguide which is integrated into the circuit board or is applied to the circuit board. For this purpose, the light is deflected for example via deflection means integrated into the optical waveguide, for instance a deflection mirror, within the optical waveguide. Equally, it is possible for the deflection means not to be integrated directly into the optical waveguide and merely to be configured in the beam path in such a way that the light is coupled into the optical waveguide via the deflection means.

In accordance with another feature of the invention, the entire transceiver module is encapsulated by a molded black plastics composition such that there is only one connection for the integrated optical waveguide. The integrated optical waveguide may be composed of a multiplicity of materials (glass, plastic, ceramic, etc.).

In the simplest case, an optical waveguide is dispensed with and the transceiver module is encapsulated by a molded plastics composition that is provided merely with one opening, through which light which is incident or emergent perpendicularly to the circuit board is coupled directly to or from the optoelectronic transducer. Such light, for example, can originate from or be coupled to an optical fiber.

In both cases, the transceiver module preferably has an external contour such that it is suitable for use as a counterpart for an optical connection plug. As a result of this, an optical connection can easily be plugged onto the transceiver module. For this purpose, there may also be provided as a coupling device, an additional plastic part to which the transceiver module is coupled and which effects positioning and fixing of an optical connection plug.

In accordance with a further feature of the invention, additional passive optical functional elements are integrated on the side of the circuit board which is remote from the optoelectronic transducer. These are, for example, couplers, splitters and WDM filters. Using a splitter makes it possible, for example, to connect the transceiver module to a plurality of connections.

In accordance with a further added feature of the invention, a plastic film or a ceramic board is provided with metallization layers and is used as the support material for the circuit board. The plastic film or the ceramic board should have sufficient heat resistance to liquefied molding plastic. The use of such a material as the support material for the circuit board has the advantage that the transceiver module can more easily be encapsulated by a plastics composition by a molding process. In this case, the components of the module are configured to ensure that no potting material can get into the beam path of the module.

Using multilayer technology, the plastic film or the ceramic board having the metallization layers is preferably provided with conductor track structures. In order to produce suitable structures, the ceramic plate or plastic film is processed like a printed circuit board using photolithographic and wet-chemical processes known per se. By way of example, plastics material known under the trade name “Kapton” is used as the plastic film.

In accordance with a further additional feature of the invention, the integrated optical light structures and possible desired passive components can be applied together, in further production steps, directly on the rear side of the circuit board using known methods of thin-film technology (sputtering, chemical vapor deposition (CVD) methods, etc.) and microstructure techniques (resist coating, masking, exposure, etching, etc.). In such a standardized method, this obviates the time-consuming and cost-intensive alignment during the coupling of the optoelectronic components to existing optical waveguides.

With the foregoing and other objects in view there is provided, in accordance with the invention, a method for coupling light into and out of an optical transceiver module, that includes a step of providing an optical transceiver module that has a circuit board with a first side and a second side that is located opposite the first side. The circuit board defines a circuit board plane. The method includes steps of providing the optical transceiver module with an optoelectronic transducer located on the first side of the circuit board, and coupling light between the second side of the circuit board and the optoelectronic transducer essentially perpendicularly to the circuit board plane.

In other words, the inventive method for coupling light into and out of an optical transceiver module provides for light to be fed to the optoelectronic transducer from that side of the circuit board which is remote from the transducer, and, in the process, essentially perpendicularly to the circuit board plane. The resultant advantages have already been discussed. The light is preferably fed to the optoelectronic transducer via an optical waveguide which is integrated into the other side of the circuit board or is applied to the other side of the circuit board.

Other features which are considered as characteristic for the invention are set forth in the appended claims.

Although the invention is illustrated and described herein as embodied in an optical transceiver module and method for coupling light into and out of an optical transceiver module, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 diagrammatically shows a first embodiment of an optical transceiver module; and

FIG. 2 diagrammatically shows a second embodiment of an optical transceiver module.

### DESCRIPTION OF THE PREFERRED EMBODIMENTS

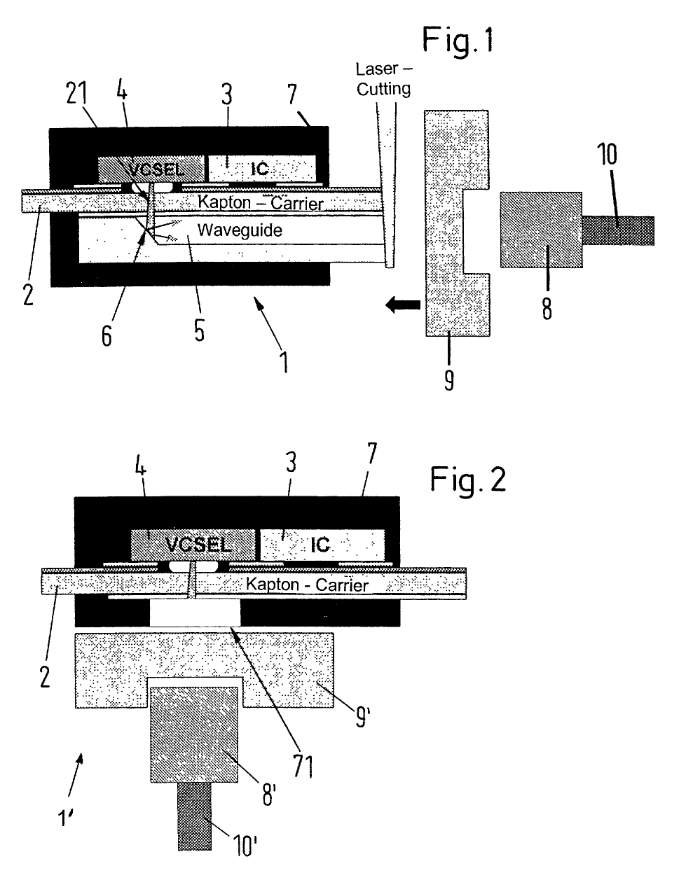

Referring now to the figures of the drawing in detail and first particularly to FIG. 1 thereof, there is shown a transceiver 1 having a circuit board 2 including a plastic film or a ceramic plate that is provided with metallization layers. The ceramic plate or plastic film 2 is provided with fine conductor track structures like a printed circuit board. In this case, complex and at the same time compact electronic circuits can be realized using multilayer technology. By way of example, Kapton is used as the material of the plastic film.

On one of its sides, the top side in FIG. 1, the circuit board 2 is populated with electronic modules 3 or such modules are integrated into the printed circuit board 2. The electronic modules are diagrammatically illustrated as integrated circuits (IC) 3.

In addition, one or more optoelectronic transducers 4 are mounted on the top side of the circuit board. FIG. 1 shows a VCSEL as an optoelectronic transducer 4. However, it is equally possible to use other optoelectronic transducers such as LEDs and photodiodes.

The optoelectronic transducer 4 is optically coupled to an optical waveguide 5 via a hole or an opening 21 in the circuit board 2. In this case, the light is coupled, or deflected, into the waveguide 5 through the hole 21 in the circuit board 2 via a deflection mirror 6 integrated in the waveguide 5. The waveguide 5 is composed of glass, ceramic or a plastic having a high melting point. A polymer waveguide, for example, is involved.

The waveguide 5 is preferably of integrated optical design in the form of a planar optical waveguide on the bottom side of the circuit board 2. However, it is likewise possible for the optical waveguide not to be of integrated optical design and to be fixed as a separate element on the circuit board 2.

The entire configuration is encapsulated by a black plastics composition 7 by a molding process. The composition protects the transceiver 1 and enables it to be handled. After the molding of the configuration, the waveguide 5 and the circuit board 2 are severed by means of a suitable cutting method. The external contour of the resulting body is directly designed as a counterpart for an optical connection plug 8. Alternatively, as shown in FIG. 1, an additional plastic part 9 is provided, which serves as a plug fixing and effects self-aligning positioning and fixing of the connection plug 8.

In further exemplary embodiments (not illustrated), additional passive optical functional elements are provided on the underside of the circuit board. By way of example, the elements are of integrated optical design combined with the waveguide 5 or are realized as separate structural parts on the underside of the circuit board 2.

The exemplary embodiment of FIG. 2 shows a transceiver 1′, which corresponds to the transceiver of FIG. 1 except for the differences explained below. In contrast to FIG. 1, light is not coupled into/out of an optical waveguide in the exemplary embodiment of FIG. 2. Instead, the light is coupled in or out directly through the opening 21 in the circuit board 2 and an adjoining opening 71 in the plastics composition 7. In FIG. 2, an optical waveguide 10′, which is configured perpendicular to the circuit board 2, is coupled via a plug fixing 9′ and a plug 8′.

The embodiment of the invention is not restricted to the exemplary embodiments described above. All that is essential to the invention is that light is fed to an optoelectronic transducer configured on one side of a circuit board directly from the other side of the circuit board and, in the process, essentially perpendicularly to the circuit board plane.

We claim:

1. An optical transceiver module, comprising:
a circuit board for accommodating electronic components, said circuit board having a first side and a second side that is located opposite said first side, said circuit board defining a circuit board plane; and
at least one optoelectronic transducer located on said first side of said circuit board such that light is directly coupled between said optoelectronic component and said second side of said circuit board and such that the light is coupled essentially perpendicularly to said circuit board plane.

2. The optical transceiver module according to claim 1, wherein said circuit board is formed with an opening through which the light is coupled.

3. The optical transceiver module according to claim 1, wherein said circuit board includes support material that is transparent for coupling the light through said circuit board.

4. The optical transceiver module according to claim 1, wherein:
said optoelectronic transducer is selected from the group consisting of an LED, a VCSEL, and a photodiode; and
said optoelectronic transducer defines a light direction selected from the group consisting of a light entry direction in which the light enters into said optoelectronic transducer essentially perpendicularly to said circuit board plane and a light exit direction in which the light exits out of said optoelectronic transducer essentially perpendicularly to said circuit board plane.

5. The optical transceiver module according to claim 1, comprising:
an optical waveguide that is connected with said circuit board in a manner selected from the group consisting of being integrated into said circuit board and being applied to said circuit board;
said optical waveguide for guiding the light on said second side of said circuit board.

6. The optical transceiver module according to claim 5, comprising a deflection device integrated into said optical waveguide, said deflection device for performing a deflection operation selected from the group consisting of deflecting the light into said optical waveguide and deflecting the light out of said optical waveguide.

7. The optical transceiver module according to claim 6, comprising:
a molded plastics composition encapsulating said circuit board, said at least one optoelectronic transducer, and said deflection device;
said optical waveguide composed of a material selected from the group consisting of a glass and a plastic, said material having a high melting point;
said optical waveguide defining only one connection.

8. The optical transceiver module according to claim 5, comprising:
a molded plastics composition encapsulating said circuit board and said at least one optoelectronic transducer;
said optical waveguide composed of a material selected from the group consisting of a glass and a plastic, said material having a high melting point;
said optical waveguide defining only one connection.

9. The optical transceiver module according to claim 8, wherein said plastics composition defines an external contour forming a counterpart for mating with an optical connection plug.

10. The optical transceiver module according to claim 1, comprising:
a molded plastics composition encapsulating said circuit board and said at least one optoelectronic transducer;
said plastics composition formed with only one opening through which the light is coupled directly to said optoelectronic transducer.

11. The optical transceiver module according to claim 10, wherein said plastics composition defines an external contour forming a counterpart for mating with an optical connection plug.

12. The optical transceiver module according to claim 11, comprising:
an additional plastic part for receiving and fixing an optical connection plug;
said additional plastic part secured to said plastics composition.

13. The optical transceiver module according to claim 1, comprising additional passive optical functional elements configured on said second side of said circuit board.

14. The optical transceiver module according to claim 1, comprising additional passive optical functional elements configured on said first side of said circuit board.

15. The optical transceiver module according to claim 1, wherein said circuit board includes support material selected from the group consisting of a plastic film and a ceramic plate; said support material provided with metallization layers.

16. The optical transceiver module according to claim 15, wherein said metallization layers are multilayer conductor track structures.

17. A method for coupling light into and out of an optical transceiver module, which comprises:
providing an optical transceiver module that has a circuit board with a first side and a second side that is located opposite the first side, the circuit board defining a circuit board plane;
providing the optical transceiver module with an optoelectronic transducer located on the first side of the circuit board;
coupling light between the second side of the circuit board and the optoelectronic transducer essentially perpendicularly to the circuit board plane.

18. The method according to claim 17, which comprises:
securing an optical waveguide to the second side of the circuit board by performing an operation selected from the group consisting of integrating the optical waveguide into the second side of the circuit board and applying the optical waveguide onto the second side of the waveguide; and
performing a coupling operation selected from the group consisting of coupling the light from the optical waveguide into the optoelectronic component and coupling the light from the optoelectronic component into the optical waveguide.

19. An optical transceiver module, comprising:
a circuit board for accommodating electronic components, said circuit board having a first side and a second side that is located opposite said first side, said circuit board defining a circuit board plane;
at least one optoelectronic transducer located on said first side of said circuit board such that light is directly coupled between said optoelectronic component and said second side of said circuit board and such that the light is coupled essentially perpendicularly to said circuit board plane; and
a body having an external contour forming a counterpart for an optical connector;
said body including plastic molded around said circuit board and said optoelectronic component.
